(19) United States
(12) Patent Application Publication
(10) Pub. No.: US 2007/0210484 A1
(43) Pub. Date: Sep. 13, 2007

(54) PROCESS FOR MAKING A MULTILAYER PART WITH A FLEXIBLE LOCAL ZONE DESIGNED, FOR EXAMPLE, TO BE USED AS INTERIOR FITTINGS FOR A MOTOR VEHICLE

(75) Inventors: Claude Fantin, Chateauroux (FR); Christophe Tirlemont, Le Poinconnet (FR)

Correspondence Address: LEYDIG VOIT & MAYER, LTD, 700 THIRTEENTH ST. NW, SUITE 300, WASHINGTON, DC, 20005-3960, US

(73) Assignee: MOLLERTECH SAS, Verrieres le Buisson (FR)

(21) Appl. No.: 11/574,090

(22) PCT Filed: Nov. 24, 2005
(86) PCT No.: PCT/FR05/02919

§ 371 Date: Mar. 6, 2007

(30) Foreign Application Priority Data
Nov. 29, 2004 (FR) 0412631

(51) Int. Cl. B29C 43/18; B29C 43/20

(52) U.S. Cl. 264/259; 264/296

(57) ABSTRACT

A method for making a multilayer part with a flexible local zone, designed for example to be used as interior fitting for a motor vehicle includes a finish layer, a rigid support layer, and at least one flexible block interposed between the finish layer and the support layer. The method includes a) shaping a peripheral edge of the flexible block by providing the edge with a tapered profile; b) fixing the flexible block on a lower surface of the finish layer at a predetermined position; c) arranging the finish layer and the flexible block in a moulding tool equipped with a punch and a die, defining between them a cavity; d) bringing a molten thermoplastic material into the cavity, beneath the lower surface of the finish layer, and exerting pressure on the material to distribute the material over the lower surface.

### FIELD OF THE INVENTION

The invention relates generally to a process for the purpose of producing a multilayer part having a flexible local area for interior fittings of motor vehicles.

More precisely, the invention relates to a process for manufacturing a multilayer part, intended, for example, for use as interior fittings for a motor vehicle, this part having a finish layer, a rigid support layer attached under the finish layer, and at least one flexible block inserted locally between the finish layer and the support layer.

### BACKGROUND

In the domain of interior fittings for motor vehicles, there are already known processes making it possible to produce such parts.

A first example of a process consists of a first step of producing an insert or support by an injection or compression technique from a composite material, a later step of adhering a foam block on the support layer, and finally of proceeding to line the part with the finish layer. This process has the disadvantage of having several manufacturing steps and requiring the use of several tools. Furthermore, this process requires the use of adhesive, which can lead to problems of contamination and risks of poor quality.

The patent EP0727301 describes a second process of this type which consists of sliding a beveled block between the finish layer and the support and then of connecting the finish layer and the support by pressing. The advantage of this process is that the part is produced in one step. However, it appears difficult to precisely position the block in the pressing mold since it is not attached to the finish or to the support. It therefore risks not being well positioned with respect to the concavities of the mold and creating a finish defect on the final part. Furthermore, this process cannot be adapted for producing the support by injection of melted thermoplastic material under the finish layer.

The patent EP1287961 describes a third example of a process of this type consisting of adhering a block of constant thickness directly on a finish layer composed of an exterior finish and a thermoplastic foam before executing the pressing on a support layer consisting of a softened composite material. The foam block does not create any defect that can be seen on the outside of the part because the foams of the block and of the finish layer melt due to the heat supplied by the support layer, and because of the modification of the punch used for the pressing. The advantage is that one operates in one or two steps. Moreover, the process can only be used for blocks consisting of thermoplastic foams and requires modification of the punch. In this case also, the process cannot be easily adapted for forming the support by injection of melted thermoplastic material under the finish layer.

### SUMMARY OF THE INVENTION

The aim of the invention is to propose a manufacturing process which palliates the disadvantages mentioned above and which makes it possible to produce the support layer by introducing the material constituting this support into the mold in the melted state.

For this purpose, the process of the invention, which is in other respects in accordance includes the following steps:

a) a peripheral edge of the flexible block is shaped, this edge given a tapered profile in order to give the object continuity of shape,

b) the flexible block is attached on a lower surface of the finish layer in a predetermined position,

c) the finish layer and the flexible block are put in a molding tool provided with a punch and a die defining a cavity between them,

d) a melted thermoplastic material is added to the cavity, under the lower surface of the finish layer, and pressure is exerted on this material so that it is distributed over the lower surface,

e) after cooling of the whole, the molding tool is opened, and the multilayer part is extracted.

According to another particularly advantageous aspect of the invention, the finish layer can include a surface covering and a layer of foam attached under the surface covering.

In this case, the layer of foam can be a polyurethane or polyolefin foam.

Furthermore, the finish layer can have a technical backing layer attached under the foam layer.

Alternatively, the finish layer can include just a surface covering and a technical backing layer attached under the surface covering.

Advantageously, the technical backing of the finish layer can be a nonwoven material or a lining made of polyester, polyamide or polypropylene or a mixture of 2 or 3 of these materials.

According to another aspect of the invention, the flexible block can be obtained by molding of a polyurethane or expanded polypropylene foam, with the tapered profile of the peripheral edge obtained directly during molding of the block.

Alternatively, the flexible block is made of meltable polyolefin or polyurethane foam.

In this case, the flexible block can be obtained by cutting of a plate of foam, with the shaping of the peripheral edge brought about by heating and pressing of the flexible block after cutting.

According to another aspect of the invention, the flexible block can be attached under the finish layer before shaping of its peripheral edge.

Alternatively, the attachment of the flexible block under the finish layer and the shaping of its peripheral edge can be done simultaneously.

According to yet another aspect of the invention, the attachment of the flexible block under the finish layer can be done with a chemical or thermal adhesive.

Advantageously, the assembling of the block under the finish layer can be done using a means making it possible to precisely situate the area of adhesion, and the finish layer provided with the flexible block can be positioned on the die in such a way that the block corresponds to the desired area on the final part.

According to yet another aspect of the invention, step d) can be carried out by injection under pressure of the thermoplastic material through the punch, after closing of the molding tool.

Alternatively, step d) can be carried out by opening the molding tool, depositing a determined quantity of thermoplastic material in the cavity, closing the tool and compressing the thermoplastic material in the cavity.

Preferably, the punch and the die can be mounted on a vertical or horizontal press.

According to yet another aspect of the invention, the flexible block can have a relatively greater upper large surface adhered on the lower surface of the finish layer, a relatively lesser lower large surface on the opposite side from the upper large surface, the peripheral edge joining the two large surfaces, the block between these two large surfaces having a small thickness relative to the dimension of the two large surfaces.

Advantageously, the peripheral edge can slope down toward the exterior of the block and toward the upper large surface from the lower large surface, this edge thus forming an obtuse angle with the lower surface of the finish layer and offering little resistance to the spreading of the melted thermoplastic material.

For this purpose, the peripheral edge can have a beveled or rounded profile.

Finally, it should be noted that the cavity of the molding tool, between the punch and the mold can have a roughly uniform thickness which is the same in the area of the block and in the other areas.

### BRIEF DESCRIPTION OF DRAWING FIGURES

Other characteristics and advantages of the invention will emerge clearly from the description given for it hereafter on an indicative and purely nonlimiting basis in reference to the appended figures among which:

FIG. 1: the figure, in the form of a view in section, describes finish layers (1) of different structures,

FIG. 2: the figure, in the form of a view in section, describes an example of part (5) obtained according to the manufacturing process of the invention,

FIG. 3: FIG. 3 illustrates two types of profile of peripheral edge (9, 10) of flexible block (7) used for producing the part of FIG. 2,

FIGS. 4a and 4b: FIGS. 4a and 4b describe a principle for assembling flexible block (7) of FIG. 3 on finish layer (1),

FIG. 5: FIG. 5 is a view in section of molding tool (17) open, with the finish layer of FIGS. 4a and 4b positioned in the tool, and

FIG. 6: FIG. 6 is a view in section of tool (17) of FIG. 5 closed, after formation of support layer (8).

### DETAILED DESCRIPTION

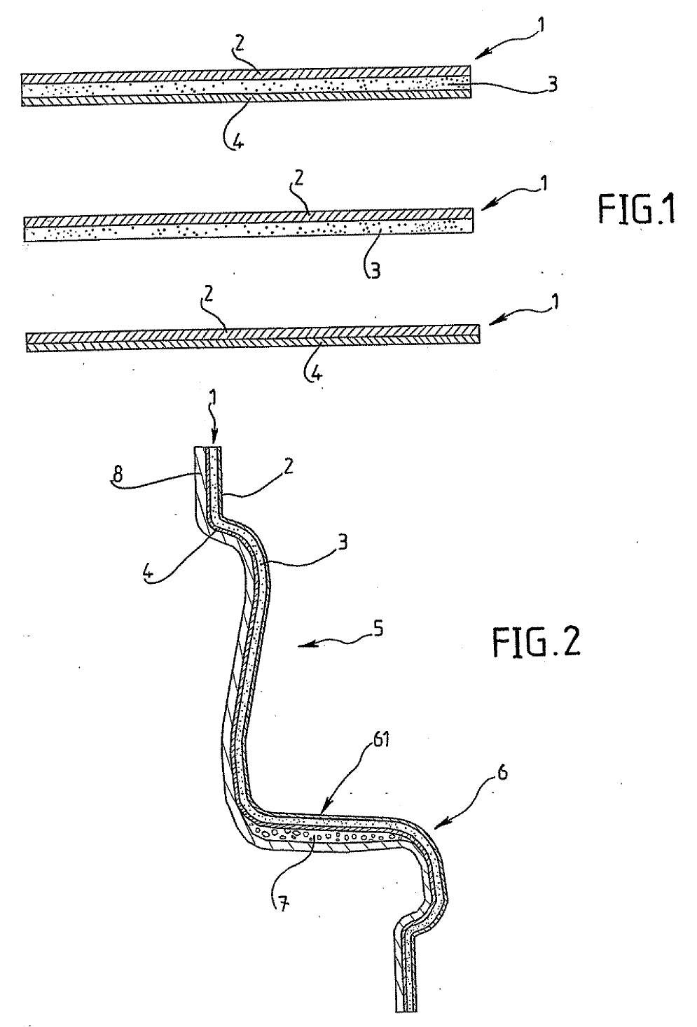

The process of the invention aims to obtain part (5), illustrated in FIG. 2, which has finish layer (1), rigid support layer (8) attached under the finish layer and lining it over practically all of its surface, and at least one flexible block (7) inserted locally between finish layer (1) and support layer (8).

In this execution example, object (5) represented is a door panel covering including arm rest (6). It is desirable to give surface (61) intended for receiving the elbow of the passenger of the vehicle additional comfort and flexibility locally.

FIG. 1 shows different types of finish layers (1) intended for use in the process.

Finish layer (1) can include three layers, surface covering (2), foam layer (3) lining surface covering (2) and attached under it, and finally technical backing layer (4) lining foam layer (3) and attached under it.

Finish layer (1) can also have just two layers: surface covering (2) and foam layer (3), or just surface covering (2) and technical backing layer (4).

Surface covering (2) can be fabric, pile fabric or vinyl or polyolefin sheet.

The foam of layer (3) can be a polyurethane or polyolefin foam.

Technical backing (4) can be a knit or a nonwoven material, made of polyester, polyamide or polypropylene or a mixture of 2 or 3 of these materials.

Foam layer (3) has a constant thickness and gives the part general comfort. It is possible to add technical backing (4) which is used as protection for foam layer (3) during formation of support (8).

Furthermore, flexible block (7) is intended to extend along all of surface (61). The total thickness of the foam layer and of the block gives the part additional comfort in the required area, in this case in this example over surface (61) of arm rest (6).

According to the invention, the process includes the following steps:

a) peripheral edge (9, 10) of flexible block (7) is shaped, this edge given a tapered profile in order to give the object continuity of shape,

b) flexible block (7) is attached on a lower surface of the finish layer in a predetermined position,

c) the finish layer and flexible block (7) are put in molding tool (17) provided with punch (18) and die (19) defining a cavity between them,

d) a melted thermoplastic material is added to the cavity, under the lower surface of the finish layer, and pressure is exerted on this material so that it is distributed over the lower surface,

e) after cooling of the whole, the molding tool is opened, and multilayer part (5) is extracted.

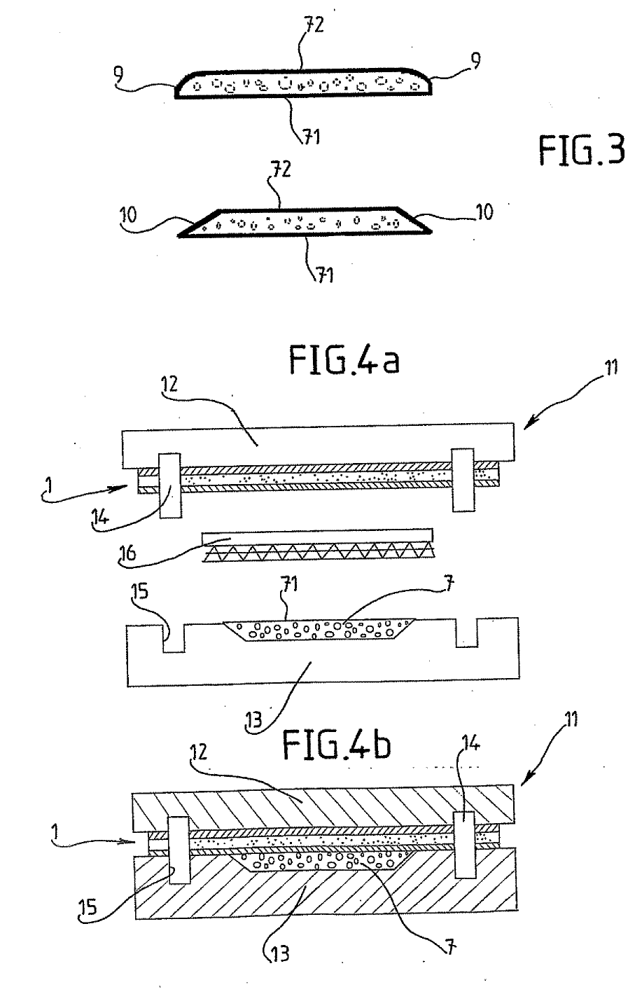

It is seen in FIG. 3 that before insertion between the finish layer and the support layer, that is to say in the nonstressed state, flexible block (7) is a thin part which has relatively greater upper large surface (71) adhered on the lower surface of finish layer (1), relatively lesser lower large surface (72) on the opposite side from upper large surface (71), with peripheral edge (9, 10) joining the two large surfaces (71, 72), the block between these two large surfaces having a small thickness relative to the dimension of the two large surfaces.

The two large surfaces (71, 72) are generally planar and parallel to each other.

Once block (7) is adhered on the lower surface of finish layer (1), that is to say in the situation of FIG. 5, peripheral edge (9, 10) slopes down toward the exterior of block (7) and toward upper large surface (71) from lower large surface (72), this edge thus forming an obtuse angle with the lower surface of the finish layer and offering little resistance to the spreading of the melted thermoplastic material in step (d) of the process.

As shown in FIG. 3, peripheral edge (9) can have a beveled profile and form a roughly planar surface connecting the two large surfaces of the block.

Peripheral edge (10) can also have a rounded profile, convex toward the exterior of block (7).

These forms of the peripheral edge of block (7) make it possible to ensure that foam block (7) does not create any excessive thickness or relief or lines after molding, on the visible surface of object (5), that is to say on finish layer (1) of the part. These reliefs are due to the residual set of the material constituting the block. In order not to create such reliefs, the peripheral edge of flexible block (7) must not be perpendicular to the two large surfaces (71, 72) of block (7) before molding.

In order to obtain this type of profile, it is possible to produce the block by molding or casting in a mold provided with a punch and a die defining a cavity with the geometry of the block (figure not represented). The tapered profile of peripheral edge (9, 10) is obtained directly during molding of the block. The block in this case can consist of flexible polyurethane or expanded polypropylene.

According to another possibility, flexible block (7) is obtained by cutting of a plate of foam. The shaping of peripheral edge (9, 10) is brought about by heating and pressing of flexible block (7) in a suitable tool after cutting. In this case, block (7) consists of a thermoplastic foam of the polyolefin type which softens with application of heat or of a meltable polyurethane which assumes the desired shape by pressing.

It is possible to consider doing the cutting, heating and forming of the edges simultaneously.

It is also possible to attach flexible block (7) under the finish layer before shaping of its peripheral edge (9, 10).

Thanks to the shape of peripheral edge (9, 10) of flexible block (7), to the precision of its positioning on finish layer (1), and to the precision of its positioning in molding tool (17), the contribution of this block is masked without generating defects of alignment, relief or marking.

For this additional step for preparation of the edge of block (7), it should be noted that there are no particular constraints as to the choice of the materials.

FIGS. 4a and 4b illustrate step b) for assembling finish layer (1) and flexible block (7) using tool (11). Finish layer (1) is attached in a precise manner on upper tool (12) using pins (14). Foam block (7) is arranged in a recess in lower tool (13), with lower large surface (72) arranged in the bottom of the housing and upper large surface (71) remaining exposed. Lower tool (12) can be provided with guiding columns, consisting in this case of pins (14), which slide in bores (15) in lower tool (13) in order to index the position of finish layer (1) with that of flexible block (7). Heating tool (16) is temporarily arranged facing upper large surface (71) in order to soften it and make it tacky. Another solution consists of providing, on upper large surface (71), a thermoplastic film or pile rendered heat-adhesive after the heating operation. The heating and softening operation can be carried out using infrared, hot air, flame or contact with a heating plate. After this operation, tools (12 and 13) are quickly closed in order to press finish layer (1) on the upper large surface of foam block (7) and to adhere this block on finish layer (1).

It is possible in this step to combine cutting of foam block (7), shaping of edge (9, 10) and assembling of block (7) on finish layer (1).

FIG. 5 illustrates an example of molding tool (17) suitable for carrying out step (d) of the process. This tool (17) is represented open and has die (19) and punch (18) which are mobile with respect to one another and which define between them a cavity when the tool is closed. This cavity defines the shape of part (5) to be manufactured. Punch (18) has opening (22) for injecting a melted thermoplastic material into the cavity.

Finish layer (1) provided with flexible block (7) is put on pins (20) arranged at the periphery, these pins making it possible to precisely situate the unit (1 and 7).

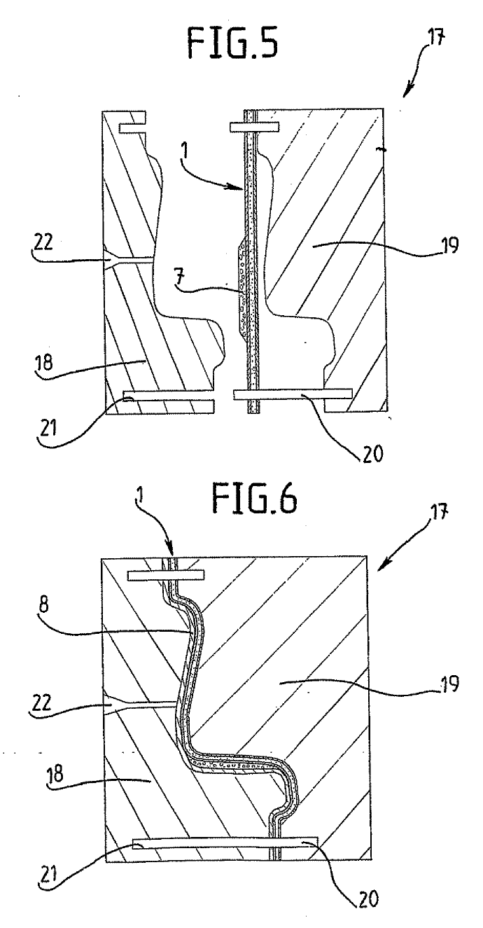

The molding tool is then closed by bringing die (19) closer to punch (18) as shown in FIG. 6, and a melted thermoplastic material is injected under high pressure between 30 and 120 bar into the cavity, under the lower surface of finish layer (1). This material fills the free space of the cavity and is distributed under the lower surface of finish layer (1) and under lower large surface (72) of flexible block (7) in order to form support layer (8). It is seen in FIG. 6 that pins (20) form columns for guiding the punch and the die toward one another, and they engage in bores (21) made in punch (18), making it possible index the position of finish layer (1) in the cavity.

It should be noted that because of the tapered profile of peripheral edge (9, 10) of block (7), this edge does not form an obstacle for the melted thermoplastic and guides the thermoplastic so that it spreads between lower large surface (72) of the block and punch (18) as shown in FIG. 6. The thermoplastic does not intrude between upper large surface (71) and the lower surface of finish layer (1). If peripheral edge (9, 10) of block (7) were upright, that is to say roughly perpendicular to the two large surfaces of the block and to the lower surface of the finish layer, this edge would constitute an obstacle for the thermoplastic which would then have a tendency to intrude between upper large surface (71) and the lower surface of finish layer (1).

Furthermore, because block (7) is adhered under finish layer (1), the thermoplastic in spreading does not shift block (7), this block remaining in its predetermined initial position. It is thus possible to position block (7) very precisely in molding tool (17).

It should be noted that the flexible block is placed on the finish layer before any deformation, and that in the mold, it is under the effect of the melted thermoplastic material that the finish layer and the block are deformed because the finish layer is flattened against the wall of the die.

After cooling of the thermoplastic enabling one to obtain the necessary rigidity of support layer (8), part (5) is extracted from tool (17) after opening of the tool. Final part (5) provided with its finish has the structure and geometry required for fulfilling its function as a covering part and meets the corresponding specifications.

In the present case, tool (17) represented is injection tool (1) but the manufacturing process can also be implemented using a compression tool whose punch does not have injection opening (22). Step d) in this case is done by putting a determined quantity of melted thermoplastic on punch (18), with molding tool (17) open. Tool (17) is then closed, and the punch and mold cavity are applied against one another with a high pressure in order to distribute the thermoplastic material under the finish layer and the block.

In terms of technology, punch (18) and die (19) can be mounted on a vertical or horizontal press.

Finally, it should be noted that the cavity has a uniform thickness between punch (18) and die (19) and does not have any excess thickness in the area occupied by block (17). The thickness is roughly the same in the area of block (7) and in the other areas of the cavity. The same molding tool (17) can therefore be used to produce parts (5) with the same final shape, with flexible block (7) and without flexible block (7).

When part (5) has a foam block, it will expand on an exterior side, that is to say on the finish layer side, after coming out of molding tool (17).

The use of a cavity of uniform thickness is made possible because the injection (or compression) of the melted thermoplastic material is done under high pressure and because peripheral edge (9, 10) of the block has a tapered profile.

It should be noted that forming support layer (8) by injection through the punch of the molding tool makes it possible to shorten the time of the cycle, which is particularly advantageous. However, in an execution variant not preferred, it is possible to form support layer (8) by introducing into molding tool (17) a plate of composite material softened beforehand by heating.

Concerning the nature of the device and of the finish layer, the flexible block can be composed of one or more layers, with materials of a different nature or different hardness such as polyolefin foam or polyurethane foam with open and/or closed cells, and the finish layer has a surface covering which can be of a different nature or structure such as slay and pick, pile fabric, knits, Alcantara, polyvinyl chloride or polyurethane type plasticized coated textiles or polyolefin sheets.

In this disclosure, we described the process with mention of the insertion of a single flexible block (7), but it is of course possible to consider depositing a number of flexible blocks according to this invention.

1. A process for manufacturing a multilayer part having a finish layer, a rigid support layer attached under the finish layer, and at least one flexible block inserted between the finish layer and the support layer, the process including:
shaping a peripheral edge of the flexible block to produce a tapered profile to give continuity of shape,
attaching the flexible block to a lower surface of the finish layer in a predetermined position,
placing the finish layer and the flexible block in a molding tool including a punch and a die with a cavity between the punch and the die,
adding a melted thermoplastic material to the cavity, under a lower surface of the finish layer, applying pressure to the thermoplastic material, and distributing the thermoplastic material over the lower surface, and
cooling, opening the molding tool, and removing the multilayer part.

2. The process according to claim 1, wherein the finish layer includes a surface covering and a layer of foam attached under the surface covering.

3. The process according to claim 2, wherein the layer of foam is a polyurethane or polyolefin foam.

4. The process according to claim 2, wherein the finish layer includes a technical backing layer attached under the layer of foam.

5. The process according to claim 1, wherein the finish layer includes a surface covering and a technical backing layer attached under the surface covering.

6. The process according to claim 4, wherein the technical backing of the finish layer is at least one of a nonwoven material, and a lining selected from the group consisting of polyester, polyamide and polypropylene.

7. The process according to claim 1, wherein the flexible block is a molded polyurethane or expanded polypropylene foam, and the tapered profile of the peripheral edge is shaped in molding of the block.

8. The process according to claim 1, wherein the flexible block is meltable polyolefin or polyurethane foam.

9. The process according to claim 8, including cutting the flexible block from a plate of foam, and shaping the peripheral edge by heating and pressing the flexible block after the cutting.

10. The process according to claim 9, including attaching the flexible block under the finish layer before shaping the peripheral edge.

11. The process according to claim 9, including attaching the flexible block under the finish layer and shaping the peripheral edge simultaneously.

12. The process according to claim 1, including attaching the flexible block under finish layer with an adhesive.

13. The process according to claim 1, including assembling the block under the finish layer using means for precisely situating an adhesion area.

14. The process according to claim 1, including positioning the finish layer with the flexible block on the die so that the block corresponds to a desired area on the multilayer part.

15. The process according to claim 1, including infecting the melted thermoplastic material through the punch under pressure, after closing of the molding tool.

16. The process according to claim 1, wherein adding the melted thermoplastic material includes, opening the molding tool, depositing a determined quantity of thermoplastic material in the cavity, closing the molding tool, and compressing the thermoplastic material in the cavity.

17. The process according to claim 1, wherein the punch and the die are mounted on a press.

18. The process according to claim 1, wherein the flexible block has a relatively larger upper surface adhered to a lower surface of the finish layer, a relatively smaller lower surface opposite the upper surface, a peripheral edge joining the upper and lower surfaces, and the block, between the upper and lower surfaces, has a thickness that is small relative to the upper and lower surfaces.

19. The process according to claim 18, wherein the peripheral edge slopes toward an exterior of the block and toward the upper surface from the lower surface, and the peripheral edge forms an obtuse angle with the lower surface of finish layer for aiding spreading of the melted thermoplastic material.

20. The process according to claim 1, wherein the peripheral edge has a beveled or rounded profile.

21. The process according to claim 1, wherein the cavity of the molding tool, between the punch and the mold cavity, has a roughly uniform thickness.

22. The process according to claim 1, wherein the flexible block includes layers of materials of different hardnesses.

23. The process according to claim 1, wherein the finish layer has a surface covering selected from the group consisting of pile fabric, knits, Alcantara, polyvinyl chloride and polyurethane plasticized coated textiles, and polyolefin sheets.
